(19) United States
(12) Patent Application Publication
(10) Pub. No.: US 2021/0287831 A1
(43) Pub. Date: Sep. 16, 2021

(54) MAGNETIC CALORIFIC COMPOSITE MATERIAL AND METHOD FOR MANUFACTURING THEREOF

(71) Applicant: Panasonic Intellectual Property Management Co., Ltd., Osaka (JP)

(72) Inventors: KAZUKI SAKAI, Osaka (JP); HIROAKI YOSHIDA, Osaka (JP)

(21) Appl. No.: 17/185,835

(22) Filed: Feb. 25, 2021

(30) Foreign Application Priority Data
Mar. 13, 2020 (JP) 2020-044453

(51) Int. Cl. H01F 1/01

(52) U.S. Cl. CPC H01F 1/015; C22C 13/02

(57) ABSTRACT

Provided is a magnetic calorific composite material including a magnetic calorific material and an alloy-coated carbon material including an alloy coat having a melting point of 150° C. or lower, in which a content of the alloy-coated carbon material is 7.5 wt % to 22.5 wt %.

### BACKGROUND

### 1. Technical Field

The present disclosure relates to a magnetic calorific composite material containing a carbon material and a method for manufacturing thereof.

### 2. Description of the Related Art

In many vapor-compression heat pumps such as air conditioners or refrigerators, alternative fluorocarbons having a high global warming potential are used. At the MOP28 held in Kigali, Rwanda in 2016, a proposal to revise the Montreal Protocol to make alternative fluorocarbons subject to new regulations was adopted. As seen from this, considerations for the environment in this area are becoming more and more important. Based on this background, there is a demand for commercialization of new heat pumps with a lower environmental load.

In recent years, expectations for magnetic refrigeration technology have increased as candidates for environment-friendly and highly efficient refrigeration technology, and research and development of room temperature magnetic refrigeration technology has been actively carried out. The magnetic refrigeration technology is a refrigeration technology that uses a phenomenon (magnetic calorific effect) in which heat is generated when a magnetic field is applied to a magnetic calorific material which is a magnetic material, and the temperature drops when the magnetic field is removed. Since there is no need to use a refrigerant such as fluorocarbons, no compressor is required, and power is reduced, it is expected that both of no use of global warming substances and energy saving will be possible.

### SUMMARY

A magnetic calorific composite material of a first aspect of the present disclosure is a magnetic calorific composite material including a magnetic calorific material; and an alloy-coated carbon material including an alloy coat having a melting point of 150° C. or lower, in which a content of the alloy-coated carbon material is 7.5 wt % to 22.5 wt %. A method for manufacturing a magnetic calorific composite material according to an aspect of the present disclosure is a method for manufacturing a magnetic calorific composite material including a magnetic calorific material and an alloy-coated carbon material including an alloy coat having a melting point of 100° C. or higher 150° C. or less, in which a mixture of the magnetic calorific material and the alloy-coated carbon material is pressurized at a temperature in a range of 100° C. to 150° C. which is a melting point of the alloy coat.

### BRIEF DESCRIPTION OF THE DRAWINGS

FIG. 1 is a cross-sectional view of a magnetic calorific composite material of the present disclosure;

FIG. 2A is a schematic view illustrating (1) a precursor preparation step in a step of manufacturing the magnetic calorific composite material of the present disclosure;

FIG. 2B is a schematic view illustrating (2) a magnetic calorific material preparation step in the step of manufacturing the magnetic calorific composite material of the present disclosure;

FIG. 2C is a schematic view illustrating (3) a pulverization step in the step of manufacturing the magnetic calorific composite material of the present disclosure;

FIG. 2D is a schematic view illustrating (4) a compounding step in the step of manufacturing the magnetic calorific composite material of the present disclosure;

FIG. 3A is a table showing a measurement result of properties of magnetic calorific composite materials according to Example 1 and Comparative Example 1 of the present disclosure; FIG. 3B is a table showing a measurement result of properties of magnetic calorific composite materials according to Example 2 and Comparative Example 2 of the present disclosure; and

FIG. 3C is a table showing a measurement result of properties of magnetic calorific composite materials according to Example 3 and Comparative Example 3 of the present disclosure.

### DETAILED DESCRIPTION(S)

The current magnetic refrigeration technology has a small cooling output [kW] and a cooling density per unit volume [W/cm²], is large and heavy, and has not been put into practical use. This is because a magnetic calorific material that generates a calorific value and a refrigerant that transports heat and forms a temperature gradient cannot efficiently exchange heat, resulting in a large loss. Therefore, in order to put the magnetic refrigeration technology to practical use, it is indispensable to improve the efficiency of heat exchange between the magnetic calorific material and the refrigerant.

In order to effectively exchange heat between the magnetic calorific material and the refrigerant, it has been proposed to process the magnetic calorific material into a microchannel shape (Japanese Patent Unexamined Publication No. 2007-291437). In the process of manufacturing a microchannel, in order to form a crystal structure that easily exhibits a magnetic calorific effect, pulverization is performed after undergoing a process of melting, quenching, and heat treatment, and then compounding is performed by sintering. In addition, compounding means has been proposed in which a carbon material is added to improve thermal conductivity of a complex, in order to further promote heat exchange with the refrigerant at the time of compounding (Japanese Patent No. 5859117).

However, a high-temperature sintering process of about 500° C. is required for compounding between the magnetic calorific material and the carbon material, phases having different magnetic properties may be precipitated (for example, α-Fe precipitation), and the magnetic calorific effect may be deteriorated. Therefore, by compounding the carbon material, the thermal conductivity of the composite material is improved, but the magnetic calorific effect is deteriorated, and the performance of the magnetic refrigeration system is deteriorated.

An object of the present disclosure is to provide a magnetic calorific composite material in which the thermal conductivity is improved and a decrease in the magnetic calorific effect is suppressed, and a method for manufacturing thereof.

Examples of embodiments of the present disclosure are:
[Item 1]

a magnetic calorific material; and an alloy-coated carbon material including an alloy coat having a melting point of 150° C. or lower, in which a content of the alloy-coated carbon material is 7.5 wt % to 22.5 wt %.
[Item 2]

The magnetic calorific composite material of Item 1, in which the magnetic calorific material is a La(FeSi)₁₃-based material.
[Item 3]

The magnetic calorific composite material of Item 1 or 2, in which the magnetic calorific material is represented by Formula (I):

La_{1-z}Aₐ(Fe_{b}B_{c}Si_{1-b-c})₁₃H_{d} (I)

in Formula (I), A is at least one rare earth element selected from the group consisting of cerium (Ce), praseodymium (Pr), and neodymium (Nd) elements, B is at least one 3d transition element selected from the group consisting of manganese (Mn) and cobalt (Co), the relationships of

0≤a≤0.5,

0.75≤b≤0.95,

0≤c≤0.3,

0.1≤d≤2.0, and

0.05≤1-b-c≤0.2

are satisfied, and a NaZn₁₃-type crystal structure is included.
[Item 4]

The magnetic calorific composite material of any one of Items 1 to 3, in which the alloy coat includes Sn and one or two or more selected from the group consisting of In, Ag, Pb, and Cd, and

a film thickness of the alloy coat is 10 to 100 nm.
[Item 5]

The magnetic calorific composite material of any one of Items 1 to 3, in which the alloy-coated carbon material includes at least one selected from carbon nanofibers and carbon nanotubes.

[Item 6]

A method for manufacturing a magnetic calorific composite material including a magnetic calorific material and an alloy-coated carbon material including an alloy coat having a melting point of 100° C. to 150° C., the method including: pressurizing a mixture of the magnetic calorific material and the alloy-coated carbon material at a temperature in a range of 100° C. to 150° C. which is a melting point of the alloy coat.

[Item 7]

The method for manufacturing a magnetic calorific composite material of Item 6, the method including: pressurizing the mixture at a temperature in a range of 0.82 times to 1 time the melting point of the alloy coat. [Item 8]

The method for manufacturing a magnetic calorific composite material of Item 6 or 7, the method including: pressurizing the mixture at 300 MPa or more.

According to the present disclosure, it is possible to achieve improvement of thermal conductivity and suppression of a decrease in the magnetic calorific effect of the magnetic calorific composite material due to compounding.

Hereinafter, the magnetic calorific composite material and the method for manufacturing thereof in the present disclosure will be described with reference to the drawings depending on the necessity. However, more detailed description than necessary may be omitted. For example, the detailed description of already well-known matters or repeated description for substantially the same configuration may be omitted. This is to avoid unnecessary redundancy of the description and to facilitate the understanding of those skilled in the art.

The applicant provides accompanying drawings and the following description for those skilled in the art to fully understand the present disclosure, and does not intend to limit the subject described in the claims therewith. It should be noted that various elements in the drawings are merely schematically and indicatively shown for the understanding of the present disclosure, and the appearance, dimensional ratio, and the like may differ from the actual ones.

### Magnetic Calorific Composite Material

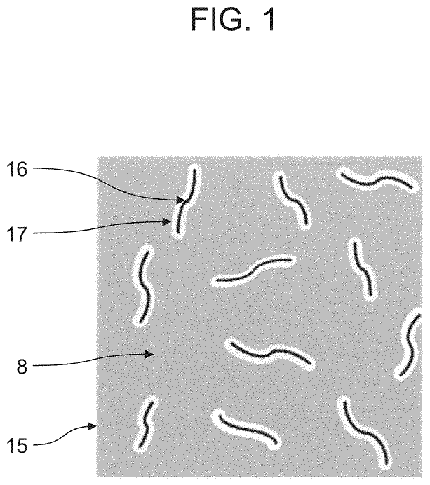

The magnetic calorific composite material in the present disclosure includes a magnetic calorific material; and an alloy-coated carbon material including an alloy coat having a melting point of 150° C. or lower. The magnetic calorific composite material has a structure in which a carbon raw material coated with an alloy (referred to as “alloy-coated carbon material”) is dispersed in the magnetic calorific material, and is compounded by chemically or physically bonding the magnetic calorific materials to each other via the alloy-coated carbon material. FIG. 1 shows a cross-sectional view of the magnetic calorific composite material of the present disclosure. A gray phase represents magnetic calorific material 8, a phase that is seen black represents carbon raw material 16, and a phase that is seen white in the periphery represents alloy membrane 17.

### Magnetic Calorific Material

The magnetic calorific effect can be expressed by including the magnetic calorific composite material and the magnetic calorific material. Examples of the magnetic calorific material include, but are not limited to, magnetic calorific materials 8 such as La(FeSi)₁₃-based material, MnAs-based material, MnFe(AsP)-based material, Gd₅(GeSi)₄-based material, and Ni—Mn—X-based material. According to the present disclosure, magnetic calorific material 8 may contain iron from a viewpoint of effectively suppressing the deterioration of properties due to the precipitation of α-Fe (a iron).

The magnetic calorific material is preferably La(FeSi)₁₃-based material from a viewpoint of expressing good thermal properties and magnetic properties. The La(FeSi)₁₃-based material is a material mainly made of La, Fe, and Si, and may contain other elements. The La(FeSi)₁₃-based material contains a NaZn₁₃ crystal structure, and preferably contains a NaZn₁₃ crystal structure as a main phase. The La(FeSi)₁₃-based material may contain a crystal structure other than the NaZn₁₃ crystal structure or an amorphous structure.

The magnetic calorific material may be a La(FeSi)₁₃-based material, which is represented by Formula (I):

La₁₋ₐAₐ(Fe_{b}B_{c}Si_{1-b-c})₁₃H_{d} (I)

In Formula (I), A may be at least one rare earth element selected from the group consisting of cerium (Ce), praseodymium (Pr), and neodymium (Nd) elements.

In Formula (I), B may be at least one 3d transition element selected from the group consisting of manganese (Mn) and cobalt (Co).

In Formula (I), a may be 0 or more, 0.1 or more, 0.15 or more, or 0.25 or more. In addition, a may be 0.6 or less, 0.5 or less, 0.25 or less, or 0.1 or less. a is preferably 0≤a≤0.5.

In Formula (I), b may be 0.75 or more, 0.8 or more, 0.84 or more, or 0.88 or more. In addition, b may be 0.95 or less, 0.9 or less, 0.88 or less, or 0.85 or less. b is preferably 0.75≤b≤0.95, for example, 0.84≤b≤0.9.

In Formula (I), c may be 0 or more, 0.01 or more, 0.03 or more, or 0.05 or more. In addition, c may be 0.4 or less, 0.3 or less, 0.1 or less, or 0.05 or less. c is preferably 0≤c≤0.3.

In Formula (I), d may be 0.05 or more, 0.1 or more, 0.3 or more, or 0.75 or more. In addition, d may be 2.5 or less, 2.0 or less, 1.5 or less, or 1.0 or less. d is preferably 0.1≤d≤2.0.

In Formula (I), 1-b-c may be 0.05 or more, 0.08 or more, 0.1 or more, or 0.13 or more. In addition, 1-b-c may be 0.25 or less, 0.2 or less, 0.16 or less, or 0.13 or less. 1-b-c is preferably 0.05≤1-b-c≤0.2, for example 0.1≤1-b-c≤0.13.

By using a magnetic calorific material having a composition in the range, deterioration of properties due to compounding can be suitably suppressed.

### Alloy-Coated Carbon Material

As the magnetic calorific composite material contains the alloy-coated carbon material, the magnetic calorific material is compounded. The alloy-coated carbon material is made by coating a carbon raw material with an alloy.

The carbon raw material is not limited, but is a solid carbon material, and an amorphous or microcrystalline carbon material such as a nanocarbon material such as fullerenes, single-phase or multilayer nanotubes, and graphene; a three-dimensional crystalline carbon material such as graphite and diamond; carbon black (for example, oil furnace black, Ketjen black, channel black, acetylene black, or thermal black), activated charcoal (for example, wood raw material, mineral raw material, or resin raw material), and carbon fiber (for example, carbon nanofiber, PAN type, or pitch type) is used. These may be used alone or in combination of two or more. The carbon raw material is preferably fibrous. A fiber diameter of the carbon raw material may be about 1 to 500 nm, and preferably about 5 to 200 nm. A fiber length of the carbon raw material may be about 0.1 to 200 μm, and preferably about 0.5 to 50 μm. Among these, the carbon raw material may be carbon nanofibers and/or carbon nanotubes. For example, a vapor phase carbon fiber can be used, and examples thereof include VGCF (registered trademark) manufactured by Showa Denko, and NT-7 or CT-15 (registered trademark) manufactured by Hodogaya Chemical Co., Ltd. In addition, a graphite ratio is preferably high, and a D/G ratio evaluated by the Raman spectrophotometer is preferably 0.15 or less.

A melting point of the alloy coat may be 150° C. or less, 148° C. or less, 146° C. or less, 144° C. or less, 142° C. or less, 140° C. or less, 138° C. or less, or 135° C. or less. The melting point of the alloy coat may be 100° C. or more, 110° C. or more, 120° C. or more, 130° C. or more, 135° C. or more, 140° C. or more, 142° C. or more, or 144° C. or more.

The alloy coat may be an alloy containing Sn and one or two or more selected from the group consisting of In, Ag, Pb, and Cd. The alloy is preferably a binary system, a ternary system, or a quaternary system or more. With this, deterioration of properties due to compounding can be suitably suppressed.

Alloy coat 17 may contain Sn in an amount of 40 wt % or more. The alloy coat may contain Sn in an amount of 20 wt % or more, 30 wt % or more, 40 wt % or more, 50 wt % or more, 60 wt % or more, 70 wt % or more, 80 wt % or more, or 90 wt % or more, and preferably contains 40 wt % or more. With this, deterioration of properties due to compounding can be suitably suppressed.

A film thickness of the alloy coat may be 1 to 500 nm, 3 to 300 nm, or 10 to 100 nm, and preferably 10 to 100 nm.

As a method for forming the alloy coat, well-known coating forming methods such as electroplating, electroless plating, vacuum vapor deposition, ion plating, physical vapor deposition (PVD) such as sputtering, and chemical vapor deposition (CVD) can be used. The film thickness can be adjusted by a known method (for example, in the case of plating, by controlling the voltage and current).

### Other Components

Depending on the necessity, the magnetic calorific composite material may contain other components such as other magnetic materials, other binders, and other additives, in addition to these described above. Composition of magnetic calorific composite material

The magnetic calorific composite material contains at least the magnetic calorific material and the alloy-coated carbon material, and may be substantially formed of the magnetic calorific material and the alloy-coated carbon material.

An amount of the alloy-coated carbon material in the magnetic calorific material complex may be 7.5 wt % or more, 10 wt % or more, 12.5 wt % or more, 15 wt % or more, or 17.5 wt % or more, and preferably 7.5 wt % or more. The amount of the alloy-coated carbon material in the magnetic calorific material complex may be less than 25 wt %, 22.5 wt % or less, 20 wt % or less, 17.5 wt % or less, 15 wt % or less, or 12.5 wt % or less, and preferably 22.5 wt % or less.

The magnetic calorific material may be 4.5 parts by weight or more, 5 parts by weight or more, 7.5 parts by weight or more, 10 parts by weight or more, or 12.5 parts by weight or more with respect to 1 part by weight of the alloy-coated carbon material. The magnetic calorific material may be 13 parts by weight or less, 10 parts by weight or less, 7.5 parts by weight or less, or 6 parts by weight or less with respect to 1 part by weight of the alloy-coated carbon material.

An amount of other components in the magnetic calorific material complex is, for example, 10 wt % or less, 5 wt % or less, 2.5 wt % or less, or 1.0 wt % or less.

### Method for Manufacturing Magnetic Calorific Composite Material

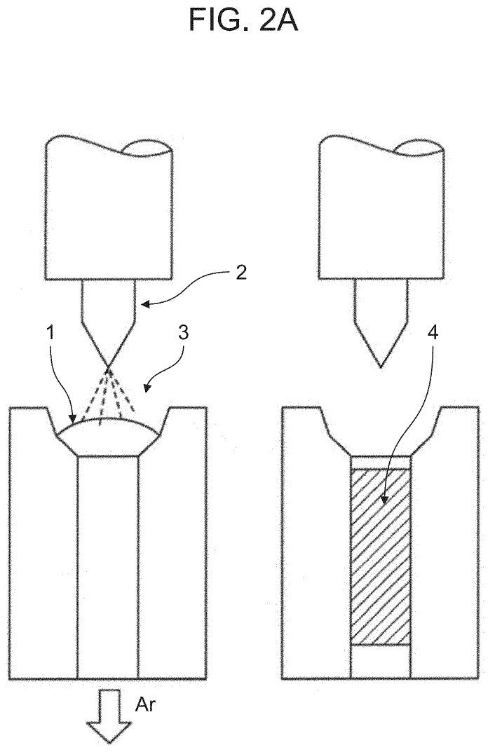

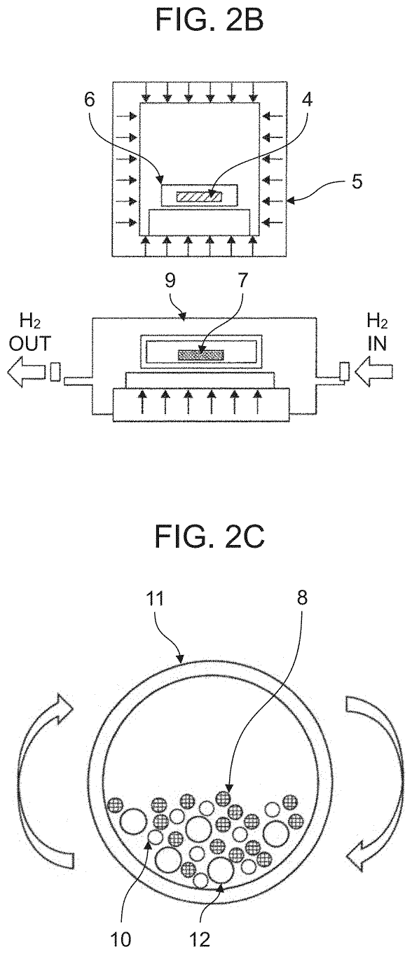

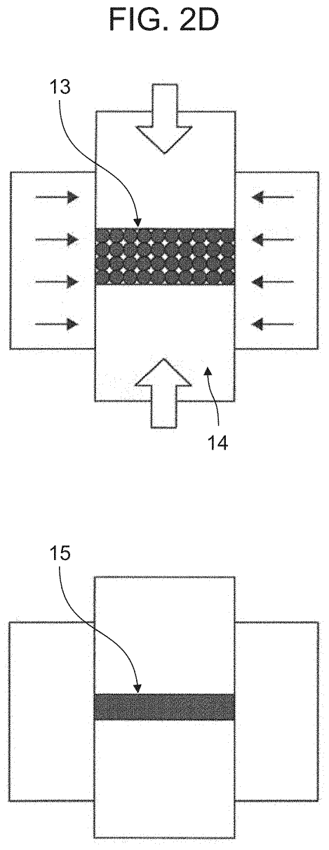

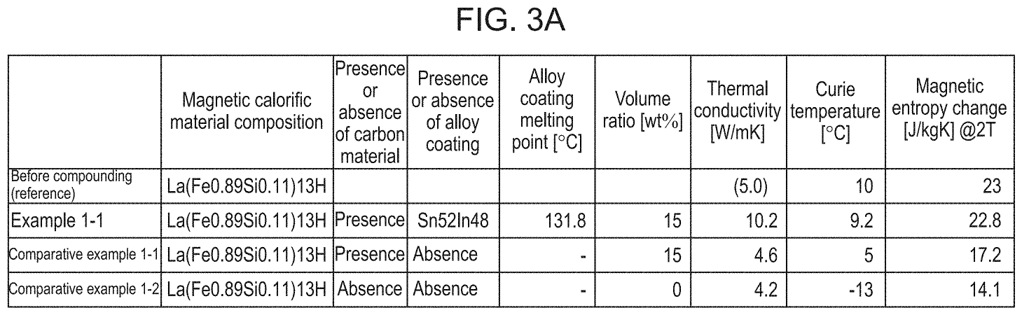

An exemplary embodiment of manufacturing steps of the magnetic calorific composite material of the present disclosure will be described with reference to FIGS. 2-1 to 2-4. Since these figures are schematic views, there is a case where the size or the shape of each component differs from the actual one.

### (1) Precursor Preparation Step

In the precursor preparation step, a precursor of magnetic calorific composite material 14 is prepared. Precursor 4 of a magnetic calorific material can be prepared by blending raw material powder 1 of a single body in a predetermined ratio and performing a suction casting method. The suction casting method is a technique of quenching by sucking a material dissolved by arc discharge 3 generated from W electrode 2 into a mold in an inert gas atmosphere such as argon (Ar) and forming precursor 4 having a fine material structure. Raw material powder 1 preferably has a purity of 4N or more. In addition, rare earths such as lanthanum (La), cerium (Ce), praseodymium (Pr), and neodymium (Nd) are volatilized during dissolution, and thus may weigh about 1 to 20 atm % greater (for example, 7.5 to 12.5 atm %).

### (2) Magnetic Calorific Material Preparation Step

Precursor 4 generally does not have a NaZn₁₃ crystal structure.

Therefore, it is possible to prepare intermediate material 7 having the NaZn₁₃ crystal structure by performing heat treatment on precursor 4 using muffle furnace 5.

It is preferable to vacuum-seal quartz tube 6 in order to prevent volatilization of rare earth elements when performing the heat treatment. A degree of vacuum at this time may be 100 Torr or less, for example, 10 Torr or less. A heating temperature may be 800° C. to 1,500° C., for example, 1,100° C. to 1,200° C. A heating time may be 6 to 48 hours, for example, 12 to 36 hours.

The Curie temperature of obtained intermediate material 7 is around −100° C. In order for use at room temperature, it is necessary to set the Curie temperature to 0° C. or higher, preferably 5° C. or higher, and more preferably 10° C. or higher. Therefore, by using raising the Curie temperature by increasing an inter-lattice distance of the NaZn₁₃ crystal structure, it is possible to obtain magnetic calorific material 8 in which hydrogen (H) is occluded in the crystal structure. Specifically, intermediate material 7 was put into tube furnace 9 filled with hydrogen and heated to occlude hydrogen. The heating temperature at this time may be 100° C. to 300° C., for example, 180° C. to 250° C. By controlling a heat treatment temperature, a hydrogen occlusion amount can be changed and the Curie temperature can be optionally controlled.

### (3) Pulverization Step

Obtained magnetic calorific material 8 and alloy-coated carbon material 10 serving as a binder are pulverized and mixed. A method of pulverization is not particularly limited, and a known method can be used. Pulverization and mixing may be performed at the same time.

For example, magnetic calorific material 8 and alloy-coated carbon material 10 having a melting point of 150° C. or lower are placed in ball mill container 11, and pulverized and mixed using a ball mill device to obtain carbon-containing magnetic calorific material powder 13. Depending on the type of device, a crushing time and crushing strength can be appropriately determined in order to obtain a desired particle size and the like. Particle size D₅₀ of the carbon-containing magnetic calorific material powder 13 may be 0.1 to 500 μm, 10 to 100 μm, 25 to 75 μm, or 40 to 60 μm.

### (4) Compounding Step

In the compounding step, carbon-containing magnetic calorific material powder 13 can be heated and pressurized by thermal press device 14 to prepare bulk-shaped magnetic calorific composite material 17. Although heating and pressurization may be performed separately, it is generally preferable to perform heating and pressurization at the same time.

The heating temperature is preferably 150° C. or lower, and preferably the melting point of alloy 10 or lower. The heating temperature may be 100° C. or higher, 120° C. or higher, or 130° C. or higher. The heating temperature is preferably the melting point of alloy 10 or lower. The heating temperature of alloy 10 is 0.82 times or more, 0.85times or more, 0.90 times or more, or 0.92 times or more with respect to the melting point (° C.) of alloy 10. The heating temperature of alloy 10 may be less than 1 times, 0.99 times or less, 0.98 times or less, 0.97 times or less, or 0.96 times or less, and preferably 0.98 times or less with respect to the melting point (° C.) of alloy 10. By setting the heating temperature within the range so that the alloy having a melting point of the melting point of alloy 10 or higher is not completely melted, deterioration of magnetic properties and deterioration of thermal conductivity due to compounding can be suitably suppressed, and at the same time, good mechanical properties of composite materials can also be achieved.

A pressure may be 200 MPa or more, 300 MPa or more, 400 MPa or more, 500 MPa or more, or 600 MPa or more, preferably 300 MPa or more, and more preferably 500 MPa or more. In addition, the pressure may be 1.5 GPa or less, or 1 GPa or less.

The heating time and the pressurization time may be 1 minute or more, 3 minutes or more, 5 minutes or more, 8 minutes or more, or 10 minutes or more, respectively. The heating time and the pressurization time may be 360 minutes or less, 180 minutes or less, 100 minutes or less, 50 minutes or less, 30 minutes or less, or 15 minutes or less, respectively.

### EXAMPLES

Hereinafter, the present disclosure will be described in more detail with reference to manufacturing examples, examples, and comparative examples, but the present disclosure is not limited to these examples.

### Manufacturing Example

A magnetic calorific composite material was manufactured by the following steps.

### (1) Precursor Preparation Step

Raw material powders of a single body element were prepared in a predetermined ratio, and a precursor of a magnetic calorific material was prepared by a suction casting method in an inert gas atmosphere. As the raw material powders, those having a purity of 4N were used. In addition, rare earths such as lanthanum (La), cerium (Ce), praseodymium (Pr), and neodymium (Nd) were weighed 10 atm % greater since these were volatilized during dissolution.

### (2) Magnetic Calorific Material Preparation Step

The obtained precursor was subjected to heat treatment using a muffle furnace to prepare an intermediate material having a NaZn₁₃ crystal structure. Specifically, in order to prevent volatilization of rare earth elements, a quartz tube was vacuum-sealed so that the degree of vacuum was 10 to 5 Torr, and heat treatment was performed at 1,100° C. to 1,200° C. for 12 to 36 hours to obtain an intermediate material. The obtained intermediate material was put into a tube furnace filled with hydrogen and heated to 180° C. to 250° C. to occlude hydrogen. By controlling the heat treatment temperature, the hydrogen occlusion amount can be changed and the Curie temperature can be optionally controlled.

### (3) Pulverization Step

The magnetic calorific material and an alloy-coated carbon material serving as a binder were placed in a ball mill container and pulverized at 300 rpm for 24 hours so that the particle size was D50=50±10 μm to obtain a carbon material-containing magnetic calorific material powder. In the ball mill, a ceramic ball having a diameter of 3 mm was used. In addition, the alloy coat was a Sn-based alloy containing Sn as a main material, and an alloy having a particle size of 100 to 200 μm was used.

### (4) Compounding Step

The carbon-containing magnetic calorific material powder was pressurized and heated by a thermal press device to prepare a bulk-shaped (square with a side of 20 mm square and a thickness of 2 mm) magnetic calorific composite material. The heating temperature applied to the material was a temperature obtained by multiplying the melting point of the alloy by 0.95 so that the alloy would not completely melt, and the pressure was 500 MPa. The pressure was maintained at 500 MPa for 10 minutes and then slowly cooled to obtain a magnetic calorific composite material.

### Evaluation of Magnetic Calorific Composite Material

Thermal properties, mechanical properties, and magnetic properties of the magnetic calorific composite material were evaluated. Specifically, for the thermal properties, thermal conductivity was measured using a laser flash method thermal conductivity measuring device (LFA-502 manufactured by Kyoto Denshi Kogyo Co., Ltd.). In addition, for the magnetic properties, the Curie temperature and a change in the magnetic entropy (magnetic calorific effect) at a time of 2T application were measured using a physical property measurement system (PPMS manufactured by Quantum Design Co., Ltd.).

### Example 1: Examination of Binder

In order to confirm the effectiveness of the magnetic calorific composite material of the present disclosure, a magnetic calorific composite material containing an alloy-coated carbon material, a carbon material-containing composite material which is an existing composite material, and a magnetic calorific material sintered body not using a binder were prepared, and comparison in thermal properties and magnetic properties was performed. For the magnetic calorific material, La(Fe_{0.89}Si_{0.11})₁₃H in which a=0, b=0.89, c=0, d=1.0 of La₁₋ₐAₐ(Fe_{b}B_{c}Si_{1-b-c})₁₃H_{d} were denoted was used commonly in Example 1-1 and Comparative Examples 1-1 to 1-2.

### Example 1-1

As a carbon raw material, VGCF-H (registered trademark) manufactured by Showa Denko Co., Ltd., which is a carbon nanotube with a fiber system diameter of 150 nm, a fiber length of 50 μm, and a thermal conductivity of 1,200 W/(m·K), was used, and an alloy coat was formed such that a film thickness was 10 nm around the carbon raw material by electroless plating of a dual system of SnIn to obtain an alloy-coated carbon material. Using the obtained alloy-coated carbon material, a magnetic calorific material complex was obtained according to the above-mentioned manufacturing example. The amount of the alloy-coated carbon material was 15 wt % of the magnetic calorific material complex.

### Comparative Example 1-1

The magnetic calorific material obtained by the step and the same carbon raw material as that in Example 1-1 not subjected to alloy coat were sintered for 2 hours by the SPS method (plasma sintering method) to obtain a magnetic calorific material complex. The amount of carbon material was 15 wt % of the magnetic calorific material complex.

### Comparative Example 1-2

Only the magnetic calorific material obtained by the step was sintered for 2 hours by the SPS method (plasma sintering method) to obtain a magnetic calorific material sintered body.

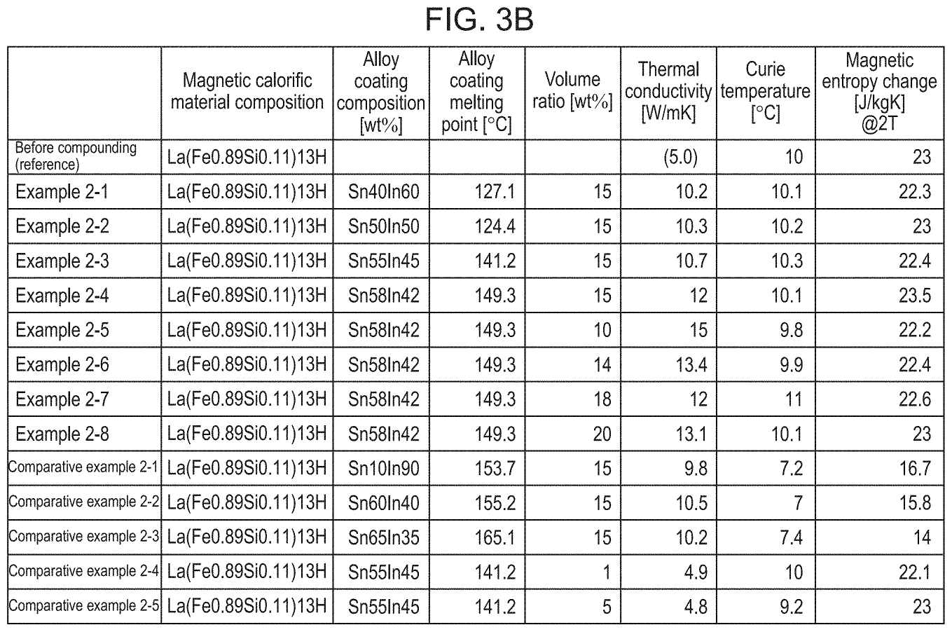

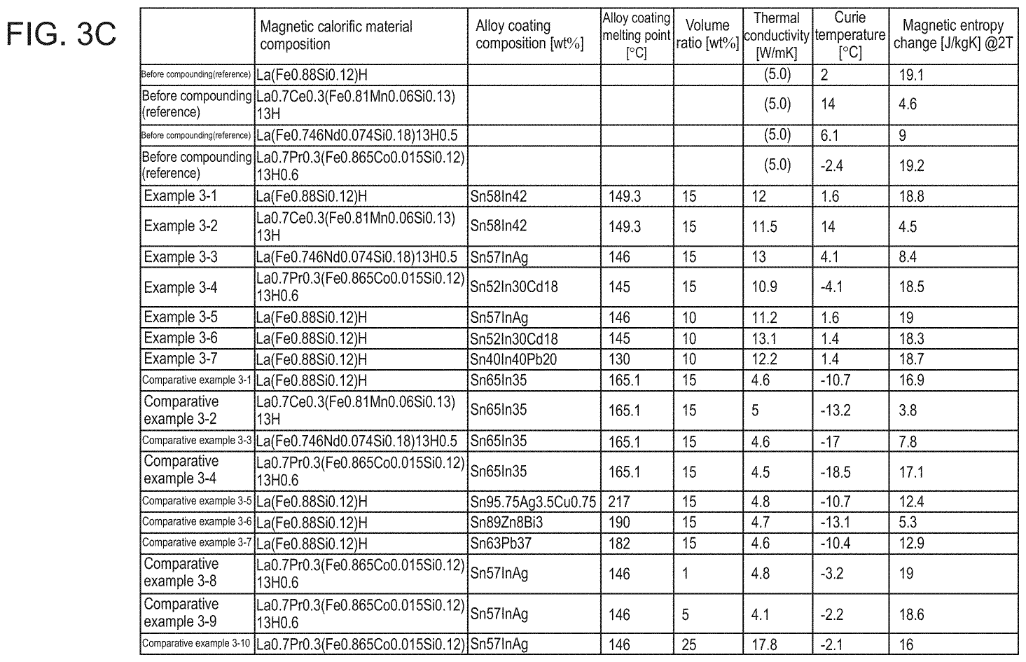

FIG. 3A shows results of comparative verification of the thermal properties and magnetic properties of Example 1-1, and Comparative Examples 1-1 and 1-2, respectively.

Various properties of the magnetic calorific material La(Fe_{0.89}Si_{0.11})₁₃H before compounding as the reference are as follows.

Thermal conductivity=5.0 W/mK

Curie temperature=10° C.

Magnetic entropy change (2T application)=23 J/kgK

After the compounding, it is desirable that the thermal conductivity, which is a thermal property, is improved by the numerical values, and the Curie temperature and the magnetic entropy change, which are magnetic properties, are not significantly deteriorated from the numerical values.

In Example 1-1, thermal properties were significantly improved by compounding but deterioration of the magnetic properties was not caused.

On the other hand, in Comparative Example 1-1, which is a composite material containing a carbon material not subjected to alloy coat, both the thermal properties and the magnetic properties were significantly deteriorated. It is considered that this is because a space is generated in a contact portion between the magnetic calorific material and the carbon material not subjected to alloy coat, and this served as thermal resistance to deteriorate the thermal conductivity. In addition, it is considered that since it was in a high temperature state of 600° C. or higher during SPS sintering, the magnetic properties were deteriorated due to the precipitation of α-Fe.

In addition, in Comparative Example 1-2, which is a magnetic calorific material sintered body, both the thermal properties and the magnetic properties were not sufficient. It is considered that this is because a carbon material serving as a binder was not used, a space is generated inside the sintered body, and this served as thermal resistance to deteriorate the thermal conductivity. In addition, similar to Comparative Example 1-2, it is considered that since it was in a high temperature state of 600° C. or higher during SPS sintering, the magnetic properties were deteriorated due to the precipitation of α-Fe.

### Example 2: Examination of Melting Point and Content of Alloy

In order to confirm the effectiveness of the melting point of the alloy coat and the content of the alloy-coated carbon material, the melting point and the content of the alloy coat were changed, and a magnetic calorific composite material was prepared and evaluated.

The details of the prepared magnetic calorific material complex will be described below.

Similar to Example 1, for the magnetic calorific material, La(Fe_{0.89}Si_{0.11})₁₃H in which a=0, b=0.89, c=0, d=1.0 of La₁₋ₐAₐ(Fe_{b}B_{c}Si_{1-b-c})₁₃H_{d} were denoted was used.

For the carbon raw material, carbon nanofibers having a fiber diameter of 100 nm, a fiber length of 50 μm, and a thermal conductivity of 1,000 W/(m K) were used.

The alloy film thickness of the alloy-coated carbon material was 100 nm.

### Examples 2-1 to 2-8 and Comparative Examples 2-1 to 2-5

In addition, for the alloy coat, a dual system of SnIn was used, and the melting point was controlled by changing a ratio of Sn to 10 to 65 wt % and changing a ratio of In to 35 to 90 wt % in the composition ratio as shown in FIG. 3B. A magnetic calorific material complex was prepared according to the above-mentioned manufacturing example.

FIG. 3B shows results of evaluating thermal properties, mechanical properties, and magnetic properties of the prepared magnetic calorific composite material.

Various properties of the magnetic calorific material La(Fe_{0.89}Si_{0.11})₁₃H before compounding as a reference are as follows (similar to Example 1).

Thermal conductivity=5.0 W/mK

Curie temperature=10° C.

Magnetic entropy change (2T application)=23 KJ/kgK

It is preferable that the properties after compounding are not significantly decreased from the reference value.

From Examples 2-1 to 2-4, it is recognized that it is possible to form a magnetic calorific composite material that improves thermal conductivity and has little deterioration in magnetic properties in a case where the melting point of the alloy coat is 150° C. or lower.

On the other hand, in view of Comparative Examples 2-1 to 2-3, the magnetic properties are deteriorated. It is considered that this is because a compounding temperature rises by using an alloy exceeding 150° C., and deterioration of magnetic properties due to the precipitation of α-Fe (a iron) is generated.

It is recognized that in Examples 2-5 to 2-8, it is possible to form a composite material that improves thermal conductivity and has little deterioration in magnetic properties. On the other hand, in Comparative

Example 2-4 in which the content of the alloy-coated carbon material is 1 wt % and Comparative Example 2-5 in which the content of the alloy-coated carbon material is 5 wt %, it was recognized that the thermal properties are improved while there is no deterioration in magnetic properties. It is considered good that this is because the content of the alloy-coated carbon material is small, and the effect as a thermal property improving component could not be obtained.

### Example 3: Examination of Composition

In order to confirm the effectiveness of the types of the magnetic calorific material and the alloy coat, the magnetic calorific material and the alloy were changed to prepare a magnetic calorific material complex.

The details of the prepared magnetic calorific material complex will be described below.

As the carbon raw material, carbon nanofibers having a fiber diameter of 100 nm, a fiber length of 20 μm, and a thermal conductivity of 1,000 W/(m were used.

The alloy film thickness was 50 nm.

### Example 3-1

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₆₈In₃₂ to obtain an alloy-coated carbon material. The content of the alloy-coated carbon material was set to 15 wt %, and a magnetic calorific material complex was prepared according to the above-mentioned manufacturing example.

### Example 3-2

For the magnetic calorific material, La_{0.7}Ce_{0.3}(Fe_{0.81}Mn_{0.06}Si_{0.13})₁₃H in which A=cerium (Ce), B=manganese (Mn), a=0.3, b=0.87, c=0.06, d=1.0 of La₁₋ₐAₐ(Fe_{b}B_{c}Si_{1-b-c})₁₃H_{d} were denoted was used.

The carbon raw material was subjected to an alloy coat having a composition of Sn₅₈In₄₂ to obtain an alloy-coated carbon material. The content of the alloy-coated carbon material was set to 15 wt %, and a magnetic calorific material complex was prepared according to the above-mentioned manufacturing example.

### Example 3-3

For the magnetic calorific material, La(Fe_{0.746}Nd_{0.074}Si_{0.18})₁₃H _{0.5} in which B=neodymium (Nd), a=0, b=0.846, c=0.074, d=0.5 of La₁₋ₐAₐ(Fe_{b}B_{c}Si_{1-b-c})₁₃H_{d} were denoted was used.

The carbon raw material was subjected to an alloy coat having a composition of Sn₅₇In₄₀Ag₃ to obtain an alloy-coated carbon material. The content of the alloy-coated carbon material was set to 15 wt %, and a magnetic calorific material complex was prepared according to the above-mentioned manufacturing example.

### Example 3-4

For the magnetic calorific material, La_{0.7}Pr_{0.3}(Fe_{0.865}Co_{0.015}Si_{0.12})₁₃H _{0.6} in which A=praseodymium (Pr), B=cobalt (Co), a=0.3, b=0.865, c=0.015, d=0.6 of La₁₋ₐAₐ(Fe_{b}B_{c}Si_{1-b-c})₁₃H _{d} were denoted was used.

The carbon raw material was subjected to an alloy coat having a composition of Sn₅₂In₃₀Cd₁₈ to obtain an alloy-coated carbon material. The content of the alloy-coated carbon material was set to 15 wt %, and a magnetic calorific material complex was prepared according to the above-mentioned manufacturing example.

### Example 3-5

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₅₇In₄₀Ag₃ to obtain an alloy-coated carbon material. The content of the alloy-coated carbon material was set to 10 wt %, and a magnetic calorific material complex was prepared according to the above-mentioned manufacturing example.

### Example 3-6

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₅₂In₃₀Cd₁₈ to obtain an alloy-coated carbon material. The content of the alloy-coated carbon material was set to 10 wt %, and a magnetic calorific material complex was prepared according to the above-mentioned manufacturing example.

### Example 3-7

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₄₀In₄₀Pb₂₀ to obtain an alloy-coated carbon material. The content of the alloy-coated carbon material was set to 10 wt %, and a magnetic calorific material complex was prepared according to the above-mentioned manufacturing example.

### Comparative Example 3-1

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₆₅In₃₅ to obtain an alloy-coated carbon material. The content of the alloy-coated carbon material was set to 15 wt %, and a magnetic calorific material complex was prepared according to the above-mentioned manufacturing example.

### Comparative Example 3-2

For the magnetic calorific material, La_{0.7}Ce_{0.3}(Fe_{0.81}Mn_{0.06}Si_{0.13})₁₃H in which A=cerium (Ce), B=manganese (Mn), a=0.3, b=0.87, c=0.06, d=1.0 of La₁₋ₐAₐ(Fe_{b}B_{c}Si_{1-b-c})₁₃H_{d} were denoted was used.

The carbon raw material was subjected to an alloy coat having a composition of Sn₆₅In₃₅ to obtain an alloy-coated carbon material. The content of the alloy-coated carbon material was set to 15 wt %, and a magnetic calorific material complex was prepared according to the above-mentioned manufacturing example.

### Comparative Example 3-3

For the magnetic calorific material, La(Fe_{0.746}Nd_{0.074}Si_{0.18})₁₃H_{0.5} in which B=neodymium (Nd), a=0, b=0.846, c=0.074, d=0.5 of La₁₋ₐAₐ(Fe_{b}B_{c}Si_{1-b-c})₁₃H_{d} were denoted was used.

The carbon raw material was subjected to an alloy coat having a composition of Sn₆₅In₃₅ to obtain an alloy-coated carbon material. The content of the alloy-coated carbon material was set to 15 wt %, and a magnetic calorific material complex was prepared according to the above-mentioned manufacturing example.

### Comparative Example 3-4

For the magnetic calorific material, La_{0.7}Pr_{0.3}(Fe_{0.865}Co_{0.015}Si_{0.12})₁₃H_{0.6} in which A=praseodymium (Pr), B=cobalt (Co), a=0.3, b=0.865, c=0.015, d=0.6 of La₁₋ₐAₐ(Fe_{b}B_{c}Si_{1-b-c})₁₃H_{d} were denoted was used.

The carbon raw material was subjected to an alloy coat having a composition of Sn₆₅In₃₅ to obtain an alloy-coated carbon material. The content of the alloy-coated carbon material was set to 15 wt %, and a magnetic calorific material complex was prepared according to the above-mentioned manufacturing example.

### Comparative Example 3-5

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn_{95.75}Ag_{3.5}Cu_{0.75} to obtain an alloy-coated carbon material. The content of the alloy-coated carbon material was set to 15 wt %, and a magnetic calorific material complex was prepared according to the above-mentioned manufacturing example.

### Comparative Example 3-6

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₈₉Zn₈Bi₃ to obtain an alloy-coated carbon material. The content of the alloy-coated carbon material was set to 15 wt %, and a magnetic calorific material complex was prepared according to the above-mentioned manufacturing example.

### Comparative Example 3-7

For the magnetic calorific material, La(Fe_{0.88}Si_{0.12})₁₃H in which a=0, b=0.88, c=0, d=1.0 of La₁₋ₐAₐ(Fe_{b}B_{c}Si_{1-b-c})₁₃H_{d} were denoted was used.

The carbon raw material was subjected to an alloy coat having a composition of Sn₆₃Pb₃₇ to obtain an alloy-coated carbon material. The content of the alloy-coated carbon material was set to 15 wt %, and a magnetic calorific material complex was prepared according to the above-mentioned manufacturing example.

### Comparative Example 3-8

For the magnetic calorific material, La_{0.7}Pr_{0.3}(Fe_{0.865}Co_{0.015}Si_{0.12})₁₃H_{0.6} in which A=praseodymium (Pr), B=cobalt (Co), a=0.3, b=0.865, c=0.015, d=0.6 of La₁₋ₐAₐ(Fe_{b}B_{c}Si_{1-b-c})₁₃H_{d} were denoted was used.

The carbon raw material was subjected to an alloy coat having a composition of Sn₅₇InAg to obtain an alloy-coated carbon material. The content of the alloy-coated carbon material was set to 1 wt %, and a magnetic calorific material complex was prepared according to the above-mentioned manufacturing example.

### Comparative Example 3-9

For the magnetic calorific material, La_{0.7}Pr_{0.3}(Fe_{0.865}Co_{0.015}Si_{0.12})₁₃H_{0.6} in which A=praseodymium (Pr), B=cobalt (Co), a=0.3, b=0.865, c=0.015, d=0.6 of La₁₋ₐAₐ(Fe_{b}B_{c}Si_{1-b-c})₁₃H_{d} were denoted was used.

The carbon raw material was subjected to an alloy coat having a composition of Sn₅₇InAg to obtain an alloy-coated carbon material. The content of the alloy-coated carbon material was set to 5 wt %, and a magnetic calorific material complex was prepared according to the above-mentioned manufacturing example.

### Comparative Example 3-10

For the magnetic calorific material, La_{0.7}Pr_{0.3}(Fe_{0.865}Co_{0.015}Si_{0.12})₁₃H_{0.6} in which A=praseodymium (Pr), B=cobalt (Co), a=0.3, b=0.865, c=0.015, d=0.6 of La₁₋ₐAₐ(Fe_{b}B_{c}Si_{1-b-c})₁₃H_{d} were denoted was used.

The carbon raw material was subjected to an alloy coat having a composition of Sn₅₇InAg to obtain an alloy-coated carbon material. The content of the alloy-coated carbon material was set to 25 wt %, and a magnetic calorific material complex was prepared according to the above-mentioned manufacturing example.

The thermal properties as the reference in Example 3 are as follows, similar to Example 2.

Thermal conductivity=5.0 W/mK

It is preferable that the properties after compounding are not significantly decreased from the reference value.

The magnetic properties are as follows for each type of magnetic calorific material based on the magnetic properties of the magnetic calorific material before compounding as a reference.

La(Fe_{0.88}Si_{0.12)11:}

Curie temperature=2° C.

Magnetic entropy change=19.1 J/kgK

La_{0.7}Ce_{0.3}(Fe_{0.81}Mn_{0.06}Si_{0.13})₁₃H :

Curie temperature=14° C.

Magnetic entropy change 4.6 J/kgK

La(Fe_{0.746}Nd_{0.074}Si_{0.18})₁₃H_{0.5}:

Curie temperature=6.1° C.

Magnetic entropy change 9 J/kgK

La_{0.7}Pr_{0.3}(Fe_{0.865}Co_{0.015}Si_{0.12})₁₃H_{0.6}:

Curie temperature=−2.4° C.

Magnetic entropy change 19.2 J/kgK

It is preferable that the properties after compounding are not significantly decreased from the reference value.

FIG. 3C shows the results of measuring the thermal conductivity, Curie temperature, and magnetic entropy change.

Examples 3-1 to 3-7 have good thermal conductivity, Curie temperature, and magnetic entropy change. It can be said that the effect of maintaining the thermal conductivity and suppressing deterioration of the magnetic properties was achieved regardless of the difference in the composition of the magnetic calorific material or the type of the alloy.

In addition, regardless of the composition difference of magnetic calorific material 8 as in Comparative Examples 3-1 to 3-7, in a case where a composite material is prepared using an alloy having a melting point of higher than 150° C., it is recognized that the magnetic properties are significantly deteriorated. It is considered that this is because the magnetic properties were deteriorated due to the precipitation of α-Fe (a iron) at the time of compounding as in Example 2. In addition, it is recognized that the magnetic properties are significantly deteriorated in the alloy coat composition Sn₈₉Zn₈Bi used in Comparative Example 3-6, in particular. It is considered that this is because lanthanum (La) of the magnetic calorific material and bismuth (Bi) of the alloy are reacted.

In view of Comparative Examples 3-8 to 3-10 in which the content was changed, it is recognized that since an alloy coat having a low melting point is used, the magnetic properties are not deteriorated but the improvement in the thermal conductivity is little. In Comparative Examples 3-8 and 3-9 in which a proportion of the alloy-coated carbon material is small, it is considered that the thermal conductivity is not improved because the carbon material that plays a role as a thermal conductivity improving component has little improvement. In Comparative Example 3-10, which has a large amount of alloy-coated carbon material, it is considered that the thermal conductivity was improved but the magnetic properties were deteriorated because the thermal conductivity improving component was larger than that of magnetic calorific material 8.

As described above, it was recognized that in a case where the melting point of the alloy used in the composite material using a LaFeSi-based magnetic calorific material is 150° C. or lower and the content is 7.5 to 22.5 wt %, the thermal conductivity of the composite material is maintained and the deterioration of magnetic properties is suppressed.

Since the magnetic calorific composite material prepared by the manufacturing method of the present disclosure is capable of improving the thermal conductivity of the composite material while preventing deterioration of magnetic properties, it is possible to realize high output and miniaturization of the magnetic refrigeration system and to apply thereof to household refrigerators and air conditioning.

What is claimed is:

1. A magnetic calorific composite material comprising:
a magnetic calorific material; and
an alloy-coated carbon material including an alloy coat having a melting point of 150° C. or lower,
wherein a content of the alloy-coated carbon material is 7.5 wt % to 22.5 wt %.

2. The magnetic calorific composite material of claim 1, wherein the magnetic calorific material is a La(FeSi)₁₃-based material.

3. The magnetic calorific composite material of claim 1,
wherein the magnetic calorific composite material includes a NaZn₁₃-type crystal structure and is represented by Formula (I):
La₁₋ₐAₐ(Fe_{b}B_{c}Si_{1-b-c})₁₃H_{d} (I),
in Formula (I), A is at least one rare earth element selected from the group consisting of cerium (Ce), praseodymium (Pr), and neodymium (Nd) elements, B is at least one 3d transition element selected from the group consisting of manganese (Mn) and cobalt (Co), and relationships of 0≤a≤0.5, 0.75≤b≤0.95, 0≤c≤0.3, 0.1≤d≤2.0, and 0.05≤1-b-c≤0.2 are satisfied.

4. The magnetic calorific composite material of claim 1,
wherein the alloy coat includes Sn and one or two or more selected from the group consisting of In, Ag, Pb, and Cd, and a film thickness of the alloy coat is 10 to 100 nm.

5. The magnetic calorific composite material of claim 1,
wherein the alloy-coated carbon material includes at least one selected from carbon nanofibers and carbon nanotubes.

6. A method for manufacturing a magnetic calorific composite material including a magnetic calorific material and an alloy-coated carbon material including an alloy coat having a melting point of 100° C. to 150° C., the method comprising:
pressurizing a mixture of the magnetic calorific material and the alloy-coated carbon material at a temperature in a range of 100° C. to 150° C., which is a melting point of the alloy coat.

7. The method for manufacturing a magnetic calorific composite material of claim 6, the method comprising:
pressurizing the mixture at a temperature in a range of 0.82 times to 1 time the melting point of the alloy coat.

8. The method for manufacturing a magnetic calorific composite material of claim 6, the method comprising:
pressurizing the mixture at 300 MPa or more.
